(19) United States
(12) Patent Application Publication
(10) Pub. No.: US 2014/0071321 A1
(43) Pub. Date: Mar. 13, 2014

(54) SOLID-STATE IMAGING DEVICE

(71) Applicant: KABUSHIKI KAISHA TOSHIBA, Tokyo (JP)

(72) Inventor: Shigeru SEYAMA, Kanagawa (JP)

(73) Assignee: Kabushiki Kaisha Toshiba, Tokyo (JP)

(21) Appl. No.: 13/780,383

(22) Filed: Feb. 28, 2013

(30) Foreign Application Priority Data
Sep. 13, 2012 (JP) 2012-201998

(51) Int. Cl. H04N 5/235

(52) U.S. Cl. CPC H04N 5/2353
USPC 348/308

(57) ABSTRACT

According to an embodiment, a solid-state imaging device includes: a pixel region in which multiple unit pixels are two-dimensionally arranged in a matrix; and a timing generator configured to control application timings of a reset signal and a read signal to be supplied to the pixel region; and during a period for performing a long-time-period exposure once for a first pixel group constituted by multiple unit pixels of the pixel region, a short-time-period exposure is performed multiple times for a second pixel group constituted by multiple unit pixels different from the unit pixels of the first pixel group.

### CROSS-REFERENCE TO RELATED APPLICATION

This application is based upon and claims the benefit of priority from the Japanese Patent Application No. 2012-201998, filed on Sep. 13, 2012; the entire contents of which are incorporated herein by reference.

### FIELD

Embodiments described herein relate generally to a solid-state imaging device.

### BACKGROUND

In a solid-state imaging device such as a digital camera, an image sensor measures light energy by strength of light emitted from an object (an exposure value) to determine brightness of each pixel on an image. A range of the exposure value (hereinafter shown as a dynamic range) that the image sensor can measure depends on a quantity of electric charge that can be accumulated in each pixel (a quantity of saturated electric charge).

Generally, a dynamic range of a solid-state imaging device is narrower than that of human eyes. Therefore, there is a problem that, when an object with a strong light-and-dark contrast is photographed, a quantity of electric charge accumulated in pixels corresponding to a light part of the object exceeds the quantity of saturated electric charge, and details of the light part cannot be seen in a picked-up image.

In order to solve the problem, a lot of techniques for expanding the dynamic range of a solid-state imaging device are proposed. Among those, a method of combining an image exposed for a long time period and an image exposed for a short time period is commonly used as a method of expanding the dynamic range.

A method of expanding the dynamic range is a method in which, after picking up an image of an object by performing long-time-period exposure, an image of the object is immediately picked up by performing short-time-period exposure, and both images are combined. (Hereinafter, the image obtained by picking up an image of an object with long-time-period exposure is referred to as a long-time-period exposure image, and the image obtained by picking up an image of an object with short-time-period exposure is referred to as a short-time-period exposure image.)

However, in the method, since an image-pickup time period during which an image of the object is picked up to obtain the long-time-period exposure image does not correspond to an image-pickup time period during which an image of the object is picked up to obtain the short-time-period exposure image, blur width of the object differs between the picked-up images. Therefore, there is a problem that the composite image is an image giving an unnatural feeling.

### BRIEF DESCRIPTION OF THE DRAWINGS

FIG. 1 is a block diagram illustrating an example of a configuration of a solid-state imaging device according to the present embodiment;

FIG. 2 is a diagram illustrating a configuration of an image sensor 1 according to the present embodiment;

FIG. 3 is a timing chart illustrating a method of driving the image sensor 1; and

FIG. 4 is a block diagram illustrating an example of a configuration of a solid-state imaging device according to a second embodiment.

### DETAILED DESCRIPTION

A solid-state imaging device of an embodiment includes: a pixel region in which multiple unit pixels are two-dimensionally arranged in a matrix; and a timing generator configured to control application timings of a reset signal and a read signal to be supplied to the pixel region; and during a period for performing a long-time-period exposure once for a first pixel group constituted by multiple unit pixels of the pixel region, a short-time-period exposure is performed multiple times for a second pixel group constituted by multiple unit pixels different from the unit pixels of the first pixel group.

### First Embodiment

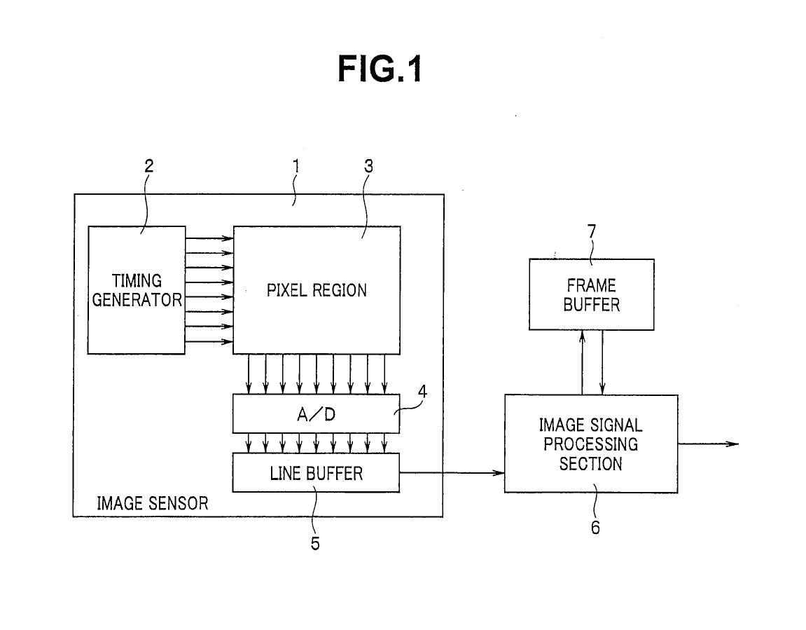

First, a configuration of a solid-state imaging device according to the present embodiment will be described with reference to FIG. 1. FIG. 1 is a block diagram illustrating an example of the configuration of the solid-state imaging device according to the present embodiment.

The solid-state imaging device according to the present embodiment is mainly configured with an image sensor 1, for example CMOS image sensor, an IPS (image signal processor; hereinafter referred to as an image signal processing section 6) and a frame buffer 7.

The image sensor 1 is provided with a pixel region (imaging region) 3 in which multiple unit pixels (unit cells) are two-dimensionally arranged in a matrix; a timing generator 2 configured to control timings of applying a signal controlling a timing of starting accumulation of electric charge (hereinafter referred to as a reset signal) and a signal controlling a timing of reading out accumulated electric charge (hereinafter, referred to as a read signal) to the pixel region 3, and controlling an operation of driving the pixel region 3; and an A/D converter 4 configured to convert a pixel signal outputted from the pixel region 3, from an analog signal to a digital signal; and a line buffer 5 configured to temporarily store digital pixel signals outputted from the A/D converter 4.

The frame buffer 7 has a capacity of temporarily storing pixel signals constituting a long-time-period exposure image corresponding to one frame and pixel signals constituting short-time-period exposure images corresponding to multiple frames (pixel signals constituting at least multiple short-time-period exposure images acquired during an exposure time period of the long-time-period exposure image corresponding to one frame). A digital pixel signal outputted from the line buffer 5 is inputted to the frame buffer 7 via the image signal processing section 6.

The image signal processing section 6 combines the long-time-period exposure image corresponding to one frame and the multiple short-time-period exposure images acquired within an exposure time period of the long-time-period exposure image, which are stored in the frame buffer 7, to generate an output image with a wide dynamic range and output the output image to the outside. Note that, at the time of performing the above combination of the images, the image signal processing section 6 performs various correction/adjustment processes, such as white balance adjustment and color difference adjustment, as necessary.

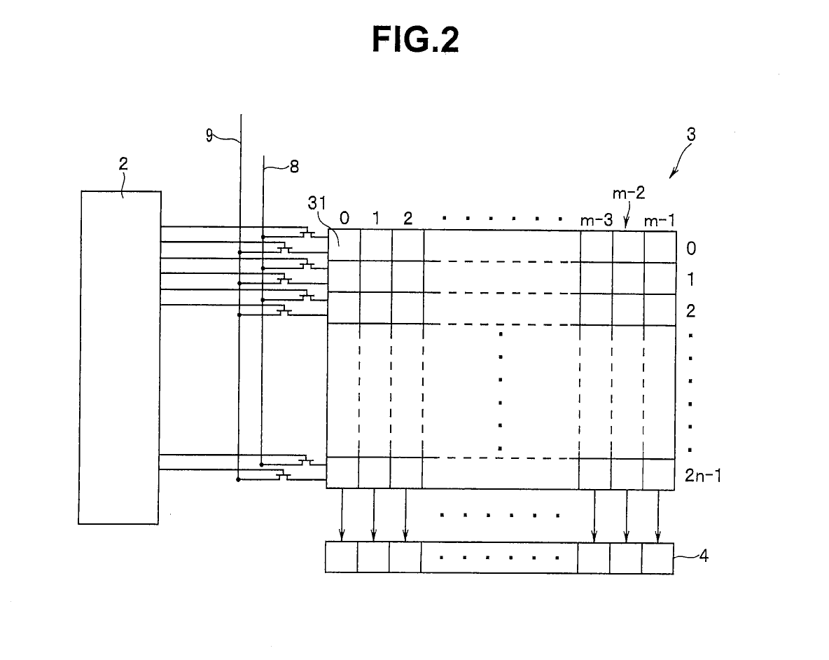

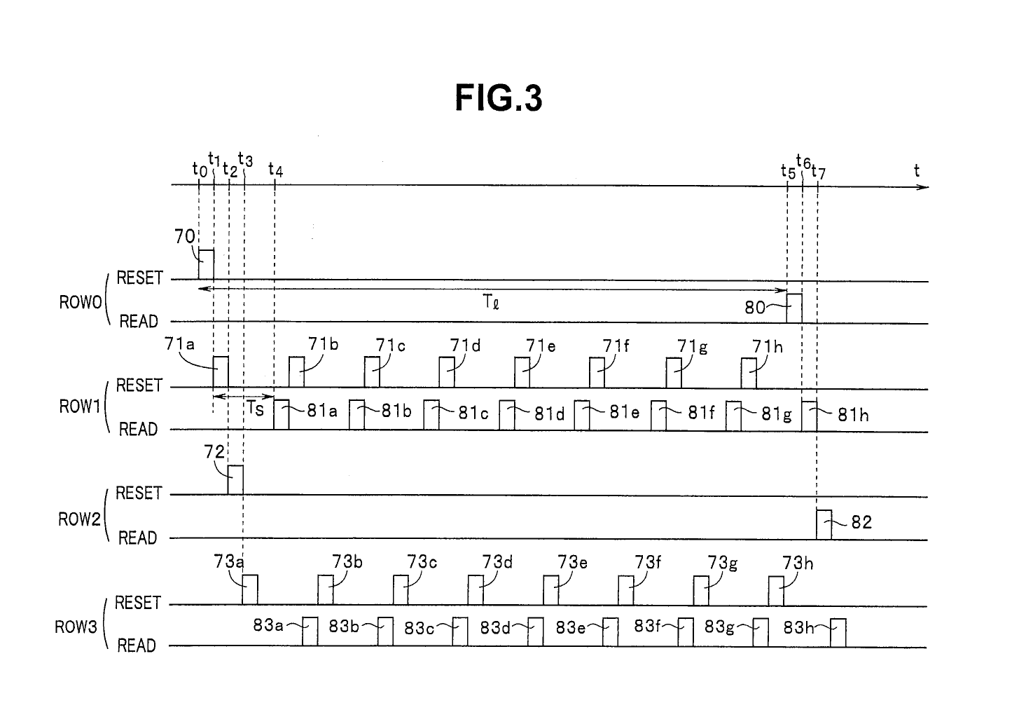

Next, a method of driving the image sensor 1 will be described with FIGS. 2 and 3. FIG. 2 is a diagram illustrating a configuration of the image sensor 1 according to the present embodiment. FIG. 3 is an example of a timing chart illustrating the method of driving the image sensor 1. As shown in FIG. 2, the pixel region 3 of the image sensor 1 according to the present embodiment is configured with multiple unit pixels 31 which are two-dimensionally arranged in a matrix of 2n rows×m columns. A reset signal line 9 and a read signal line 8 are connected to each unit pixel 31 via each reset transistor and read transistor every row. Timings of a reset signal supplied from the reset signal line 9 and a read signal supplied from the read signal line 8 being applied to each unit pixel 31 are controlled by the timing generator 2.

Note that a reset signal or a read signal applied to the unit pixel 31 on the 0-th row is also applied to other unit pixels 31 on the same row through signal lines not shown. Therefore, the timing generator 2 can control timings of supplying a reset signal and a read signal to each unit pixel 31 of the pixel region 3, in units of rows. (That is, the timing generator 2 can control the operation of driving the pixel region 3 in units of rows.)

When a reset signal is applied, electric charge accumulated in the unit pixel 31 is reset. Incident light from an object is photoelectrically converted to a quantity of electric charge corresponding to the quantity of the incident light, and the converted electric charge is newly accumulated in the unit pixel 31 (start of exposure). When a read signal is applied, the accumulation of electric charge is stopped (end of exposure), and electric charge accumulated so far is outputted to the A/D converter 4 as a pixel signal (readout of the pixel signal). The multiple unit pixels 31 constituting the pixel region 3 include a first pixel group to be exposed for a long time period and a second pixel group to be exposed for a short time period. In the present embodiment, description will be made on the assumption that, for example, unit pixels 31 on even-number rows (row 0, row 2, row 4, . . . , row (2n−2)) are considered to constitute the first pixel group, and unit pixels 31 on odd-number rows (row 1, row 3, row 5, . . . , row (2n−1)) are considered to constitute the second pixel group. However, the way of separating the unit pixels into the first pixel group and the second pixel group is not limited thereto.

Next, timings of the reset signal and the read signal applied to each row of the pixel region 3 will be described with FIG. 3. As shown in FIG. 3, at time t₀, a reset signal 70 in a pulse is applied to the unit pixel 31 on the row 0.

When the reset signal 70 is applied, electric charge accumulated in the m unit pixels 31 on the row 0 is reset, and new accumulation of electric charge is started (start of exposure). Next, at time t₁, a reset signal 71a in a pulse is applied to each unit pixel 31 on the row 1. When the reset signal 71a is applied, exposure of m unit pixels 31 on the row 1 is started similarly to the row 0. Then, as for the 2n rows of the row 2, the row 3, . . . , the row 2n−1, reset signals 72, 73a, . . . in a pulse are sequentially applied at the timings of time t₂, t₃, . . . , and exposure is started. Note that intervals among t₀, t₁, t₂, t₃, . . . are controlled to be very short and equal.

At time t₄, a read signal 81a in a pulse is applied to each unit pixel 31 on the row 1. When the read signal 81a is applied, accumulation of electric charge is stopped in the m unit pixels 31 on the row 1 (end of exposure), and electric charge accumulated so far is outputted to the A/D converter 4 as a pixel signal (readout of the pixel signal). That is, an exposure time period Ts of each unit pixel 31 on the row 1 is (t₄−t₁).

When the pixel signal of each unit pixel 31 on the row 1 is read out by the read signal 81a, a reset signal 71b in a pulse is applied to each unit pixel 31 on the row 1, and next exposure is started. When Ts elapses after the start of exposure, a read signal 81b in a pulse is applied to each unit pixel 31 on the row 1, and second exposure ends. Similarly, a reset signal 71 in a pulse and a read signal 81 in a pulse are repeatedly applied to the row 1, and pixel signals with the exposure time period Ts are sequentially outputted to the A/D converter 4.

That is, application timings of reset signals and read signals are controlled by the timing generator 2 so that all of intervals between a reset signal 71c and a read signal 81c, between a reset signal 71d and a read signal 81d, between a reset signal 71e and a read signal 81e, between a reset signal 71f and a read signal 81f, between a reset signal 71g and a read signal 81g, and between a reset signal 71h and a read signal 81h are equal to Ts.

As for each unit pixel 31 on the row 3 also, application timings of reset signals 73a to 73h and read signals 83a to 83h are controlled by the timing generator 2 so that short-time-period exposure with the exposure time period Ts is repeatedly performed similarly to each unit pixel 31 on the row 1.

Note that, as for each unit pixel 31 on the odd-number rows of the row 5, the row 7, . . . row (2n−1) also, short-time-period exposure with the exposure time period Ts is repeatedly performed, similarly to the rows 1 and 3.

On the other hand, for each unit pixel 31 on the row 0, a read signal 80 in a pulse is applied at time t₅. When the read signal is applied, accumulation of electric charge is stopped in the m unit pixels 31 on the row 0 (end of exposure), and electric charge accumulated so far is outputted to the A/D converter 4 as a pixel signal (readout of the pixel signal). That is, an exposure time period T1 of each unit pixel 31 on the row 0 is (t₅−t₀). Similarly, for each unit pixel 31 on the row 2 also, a read signal 82 in a pulse is applied at such time t₇ that t₇−t₂=T1 is satisfied. When the read signal 82 is applied, a pixel signal with the exposure time period T1 is outputted to the A/D converter 4 from each unit pixel 31 of the row 2.

Note that, as for each unit pixel 31 on the even-number rows of the row 4, the row 6, . . . the row (2n−2) also, long-time-period exposure with the exposure time period T1 is performed similarly to the rows 0 and 2.

Note that timings of applying a reset signal and a read signal to each row are controlled so that a time period from a reset signal applied to an even-number row first to a read signal (=t₅−t₀) and a time period from a reset signal applied to an odd row first to a read signal applied eighth time (=t₆−t₁) are almost a same time period. That is, timings are controlled so that a time period required from start of exposure to end of exposure in long-time-period exposure and a time period required from start of the first exposure to end of the eighth exposure in short-time-period exposure are almost equal to each other. Furthermore, timings of applying reset signals and read signals are controlled so that, as for time intervals between reset signals applied to odd-number rows and next read signals, all the intervals are equal. That is, the timings are controlled so that all of eight exposure time periods for the first to eighth short-time-period exposures are equal.

Description will be made on a method for generating an output image from pixel signals obtained by reset signals and read signals which are timing-controlled as described above.

Like the pixel signal read from each unit pixel 31 on the row 1 by the read signal 81a, the pixel signal read from each unit pixel 31 on the row 3 by the read signal 83a, . . . , pixel signals which have been exposed from the reset signals 71a, 73a, . . . first applied to each unit pixel 31 on the odd-number rows, respectively, are stored into the frame buffer 7 from the line buffer 5 via the image signal processing section 6 after being digitized by the A/D converter 4. A first short-time-period exposure image with the exposure time period Ts is generated by the pixel signals.

Furthermore, like the pixel signal read from each unit pixel 31 on the row 1 by the read signal 81b, the pixel signal read from each unit pixel 31 on the row 3 by the read signal 83b, . . . , pixel signals which have been exposed from the reset signals 71b, 73b, . . . applied a second time to each unit pixel 31 on the odd-number rows, respectively, are also stored into the frame buffer 7 from the line buffer 5 via the image signal processing section 6 after being digitized by the A/D converter 4. A second short-time-period exposure image with the exposure time period Ts is generated by the pixel signals.

Similarly, pixel signals read by reset signals applied to each unit pixel 31 on the odd-number rows, respectively, third time, fourth time, . . . , eighth time are also stored into the frame buffer 7 from the line buffer 5 via the image signal processing section 6 after being digitized by the A/D converter 4. A third short-time-period exposure image, a fourth short-time-period exposure image, . . . , an eighth short-time-period exposure image, with the exposure time period Ts, are generated by the pixel signals.

On the other hand, like the pixel signal read from each unit pixel 31 on the row 0 by the read signal 80, the pixel signal read from each unit pixel 31 on the row 2 by the read signal 82, . . . , pixel signals which have been exposed from the reset signals 70, 72, . . . first applied to each unit pixel 31 on the even-number rows, respectively, are stored into the frame buffer 7 from the line buffer 5 via the image signal processing section 6 after being digitized by the A/D converter 4. A long-time-period exposure image with the exposure time period T1 is generated by the pixel signals.

The eight short-time-period exposure images of the row 1 stored in the frame buffer 7 are read to the image signal processing section 6 and averaged to generate one short-time-period exposure image. Furthermore, by reading out the long-time-period exposure image of the row 0 to the image signal processing section 6 from the frame buffer 7 and combining the long-time-period exposure image with the averaged short-time-period exposure image, an output image is generated.

As described above, according to the present embodiment, the unit pixels 31 constituting the pixel region 3 are separated into the first pixel group to be exposed for a long time period and the second pixel group to be exposed for a short time period, and short-time-period exposure is continuously performed for the second pixel group multiple times during the same time period as the time period for performing long-time-period exposure for the first pixel group. By averaging the multiple short-time-period exposure images obtained by short-time-period exposure performed multiple times for the second pixel group and combining the averaged image with the long-time-period exposure image to generate an output image, the image pickup time period and image pickup time of the long-time-period exposure image and the image pickup time period and image pickup time of the (averaged) short-time-period exposure image almost correspond to each other, and the amounts of blur of an object almost correspond to each other. Therefore, an image that does not give an unnatural feeling can be obtained, and the image quality of the output image can be improved.

Note that, in the example described above, the short-time-period exposure time period is set to one-eighth of the long-time-period exposure time period, and the timing generator 2 controls timings of applying reset signals and read signals so that eight short-time-period exposure images are picked up within a time period required to pick up one long-time-period exposure image. However, it is also possible to lengthen the short-time-period exposure time period so that, for example, four short-time-period exposure images are picked up within the time period required to pick up one long-time-period exposure image or, on the contrary, shorten the short-time-period exposure time period so that, for example, sixteen short-time-period exposure images are picked up within the time period required to pick up one long-time-period exposure image.

Since it is required only to pick up multiple short-time-period exposure images during almost the same time period as the time period for picking up the long-time-period exposure image, it is sufficient if at least two short-time-period exposure images are acquired. It is much better to pick up a first short-time-period exposure image obtained by applying a reset signal at almost the same timing as a reset signal for the long-time-period exposure image and a second short-time-period exposure image obtained by applying a read signal at almost the same timing as a read signal for the long-time-period exposure image. That is, the first and eighth short-time-period exposure images shown in FIG. 3 are to be acquired, but the second to seventh short-time-period exposure images are not necessarily to be acquired. For example, on the row 1 in FIG. 3, the reset signal 71a and the read signal 81a, and the reset signal 71h and the read signal 81h are necessarily to be applied to acquire pixel signals forming two short-time-period exposure images. However, the reset signal 71b to the read signal 81g are not necessarily to be applied. One or more short-time-period exposure images may be acquired between the first and eighth images. Though it is possible to expand the dynamic range more and reduce the amount of blur of an object more by acquiring more short-time-period exposure images more finely, it leads to increase in power consumption due to readout operations and increase in area due to increase in the capacity of a buffer. Therefore, it is recommended to perform optimum adjustment according to specifications.

Furthermore, though a method in which reset signals are applied sequentially from an upper-part row (row 0) toward a lower-part row (row (2n−1)) one row by one row (a focal plane shutter or a rolling shutter) is used in the example described above, a method in which the reset signals are applied to all the rows at the same time (a global shutter) may be used. In the case of the global shutter, in FIG. 3, the first reset signals 70, 71a, 72 and 73a are applied to the rows, respectively, at the same time point (for example, t₀), and exposure is started for all the rows at the same time. The read signals 80 and 82 to be applied to the even-number rows which are to be exposed for a long time period and the eighth read signals 81h and 83h to be applied to the odd-number rows are applied at the same time point (for example, t₅). Then, exposure ends for all the rows at the same time, and reading out of pixel signals are performed.

That is, in the case of the global shutter, a time period for picking up a long-time-period exposure image and a time period for picking up an averaged short-time-period exposure image correspond to each other completely, and, therefore, the amounts of blur of an object correspond to each other completely. Therefore, it is possible to obtain an image that, more sufficiently, does not give an unnatural feeling than the case of the rolling shutter and improve the image quality of an output image more.

### Second Embodiment

In the solid-state imaging device of the first embodiment described above, all pixel signals constituting multiple short-time-period exposure images acquired within a time period required to pick up one long-time-period exposure image are once stored in the frame buffer 7, and, at the image signal processing section 6, an averaged short-time-period exposure image is generated and combined with the long-time-period exposure image. However, the present embodiment is different in a point that an integral-type A/D converter is used when an analog pixel signal outputted from the pixel region 3 is digitally converted, and an averaged short-time-period exposure image is generated at the same time when the digitization is performed. Note that, in an image sensor 1′, control of the timing of applying a reset signal and a read signal to each row of the pixel region 3 is similar to that of the first embodiment.

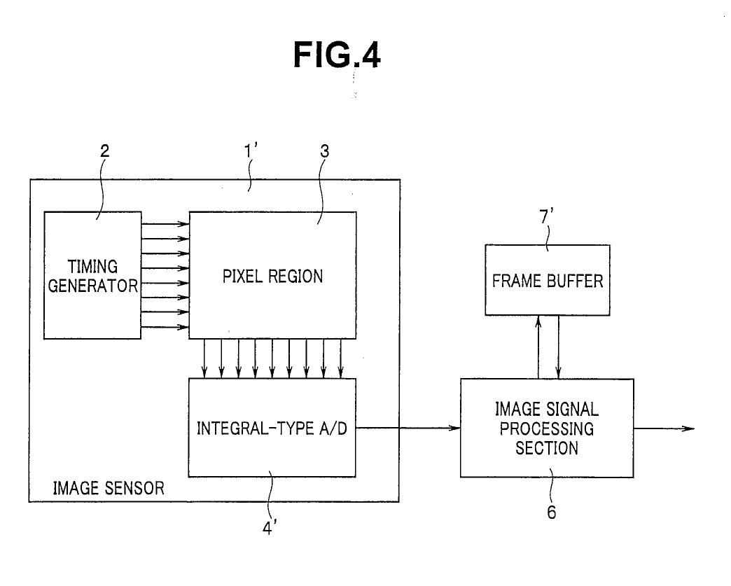

FIG. 4 is a block diagram illustrating an example of a configuration of a solid-state imaging device according to the second embodiment. That is, the solid-state imaging device of the present embodiment is different from the first embodiment in that an integral type A/D converter 4′ is used instead of the A/D converter 4 shown in FIG. 1, that the line buffer 5 is not used, and that a frame buffer 7′ has a different capacity. Since other components are the same as those of the first embodiment, they are given the same reference numerals, and description thereof will be omitted.

By configuring the solid-state imaging device as described above, it is sufficient that the frame buffer T has enough capacity to store pixel signals constituting a long-time-period exposure image corresponding to one frame and pixel signals constituting short-time-period exposure images corresponding to one frame. Therefore, it is possible to reduce the capacity in comparison with the frame buffer 7 shown in FIG. 1 and reduce the apparatus scale. Furthermore, since it is possible to average the multiple short-time-period exposure images without using the line buffer 5, the structure of the apparatus can be simplified.

Furthermore, if short-time-period exposure is performed multiple times for all pixels by integral-type A/D to continue to add images, reset and readout operations are repeated multiple times, and noise is also added. Therefore, a disadvantage occurs that the image quality deteriorates. However, by combining long-time-period exposure and short-time-period exposure to make a composite as in the present embodiment, it becomes possible to suppress noise and improve the image quality.

Note that, in the present embodiment also, similarly to the first embodiment described above, the number of short-time-period exposure images picked up within a time period for picking up one long-time-period exposure image is not limited to eight, and the number can be set to an optimum number, for example, four or sixteen.

Furthermore, the method of applying reset signals may be not the rolling shutter but the global shutter.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel region in which multiple unit pixels are two-dimensionally arranged in a matrix; and
a timing generator configured to control application timings of a reset signal and a read signal to be supplied to the pixel region; wherein
during a period for performing a long-time-period exposure once for a first pixel group constituted by multiple unit pixels arranged on one row of the pixel region, a short-time-period exposure is performed multiple times for a second pixel group constituted by multiple unit pixels arranged on the other row of the pixel region.

2. The solid-state imaging device according to claim 1, wherein the short-time-period exposure performed multiple times for the second pixel group is continuously performed.

3. The solid-state imaging device according to claim 1, wherein, the other row is adjacent to the one row.

4. The solid-state imaging device according to claim 1, wherein the one row is one of even-number rows and odd-number rows of the pixel region, the other row is the other of even-number rows and odd-number rows of the pixel region.

5. The solid-state imaging device according to claim 1, wherein a time period until the read signal is applied after applying the reset signal to the first pixel group and a time period until a last read signal is applied after applying a first reset signal to the second pixel group are equal.

6. The solid-state imaging device according to claim 1, wherein, by the short-time-period exposure performed multiple times for the second pixel group, at least a first short-time-period exposure image obtained by applying the reset signal almost at the same timing as the reset signal for the first pixel group to perform a short-time-period exposure and a second short-time-period exposure image obtained by applying the read signal almost at the same timing as the read signal for the first pixel group to perform a short-time-period exposure are picked up.

7. The solid-state imaging device according to claim 6, wherein the second short-time-period exposure performed at predetermined time intervals from the first short-time period exposure.

8. A solid-state imaging device comprising:
a pixel region in which multiple unit pixels are two-dimensionally arranged in a matrix; and
a timing generator configured to control application timings of a reset signal and a read signal to be supplied to the pixel region, and, during a period for performing a long-time-period exposure once for a first pixel group constituted by multiple unit pixels of the pixel region, perform a short-time-period exposure multiple times for a second pixel group constituted by multiple unit pixels different from the unit pixels of the first pixel group;
a frame buffer configured to hold one long-time-period exposure image obtained by the long-time-period exposure and multiple short-time-period exposure images obtained by the short-time-period exposure performed multiple times; and
an image signal processing section configured to average the multiple short-time-period exposure images to generate one average short-time-period exposure image, and combine the average short-time-period exposure image with the long-time-period exposure image to generate an output image.

9. The solid-state imaging device according to claim 8, wherein the short-time-period exposure performed multiple times for the second pixel group is continuously performed.

10. The solid-state imaging device according to claim 8, wherein, the first pixel group is adjacent to the second pixel group.

11. The solid-state imaging device according to claim 8, wherein a time period until the read signal is applied after applying the reset signal to the first pixel group and a time period until a last read signal is applied after applying a first reset signal to the second pixel group are equal.

12. The solid-state imaging device according to claim 9, wherein the multiple times are equal.

13. The solid-state imaging device according to claim 8, wherein, in the short-time-period exposure for the second pixel group, a first short-time-period exposure image for which the reset signal is applied at least almost at the same timing as the reset signal for the first pixel group to perform a short-time-period exposure and a second short-time-period exposure image for which the read signal is applied at least almost at the same timing as the read signal for the first pixel group to perform a short-time-period exposure image are picked up.

14. The solid-state imaging device according to claim 13, wherein the second short-time-period exposure performed at predetermined time intervals from the first short-time period exposure.

15. A solid-state imaging device comprising:
a pixel region in which multiple unit pixels are two-dimensionally arranged in a matrix; and
a timing generator configured to control application timings of a reset signal and a read signal to be supplied to the pixel region; and
an integral type A/D converter configured to convert an analog pixel signal inputted from the pixel region to a digital pixel signal; wherein,
during a period for performing a long-time-period exposure once for a first pixel group constituted by multiple unit pixels of the pixel region, a short-time-period exposure is performed multiple times for a second pixel group constituted by multiple unit pixels different from the unit pixels of the first pixel group, and the integral type A/D converter averages the pixel signals outputted by the short-time-period exposure image performed multiple times to convert the pixel signals to a pixel signal forming one average short-time-period exposure image.

16. The solid-state imaging device according to claim 15, further comprising an image signal processing section configured to combine one long-time-period exposure image obtained by the long-time-period exposure and the one average short-time-period exposure image to generate an output image.

17. The solid-state imaging device according to claim 15, wherein the short-time-period exposure performed multiple times for the second pixel group is continuously performed.

18. The solid-state imaging device according to claim 15, wherein, by the short-time-period exposure performed multiple times for the second pixel group, at least a first short-time-period exposure image obtained by applying the reset signal almost at the same timing as the reset signal for the first pixel group to perform a short-time-period exposure and a second short-time-period exposure image obtained by applying the read signal almost at the same timing as the read signal for the first pixel group to perform a short-time-period exposure are picked up.

19. The solid-state imaging device according to claim 15, wherein, during a period for performing the long-time-period exposure once for the first pixel group, the short-time-period exposure is performed at least twice for the second pixel group.

20. The solid-state imaging device according to claim 19, wherein a period until the read signal is applied after applying the reset signal to the first pixel group and a period until a last read signal is applied after applying a first reset signal to the second pixel group are equal.
